(19) United States
(12) Patent Application Publication
(10) Pub. No.: US 2022/0392043 A1
(43) Pub. Date: Dec. 8, 2022

(54) GENERATION OF FEATURE VECTORS FOR ASSESSING PRINT QUALITY DEGRADATION

(71) Applicant: Hewleit-Packard Development Company, L.P., Spring, TX (US)

(72) Inventors: Richard E. Maggard, Boise, ID (US); Yousun Bang, Seangnam Si (KR); Minki Cho, Pangyo (KR); Mark Shaw, Boise, ID (US); Jan Allebach, Boise, ID (US); Runzhe Zhang, Boise, ID (US); Yi Yang, Boise, ID (US)

(21) Appl. No.: 17/778,210

(22) PCT Filed: Jan. 23, 2020
(86) PCT No.: PCT/US2020/014846

§ 371 Date: May 19, 2022

(51) Int. Cl. G06T 7/00; G06V 10/25; H04N 1/00

(52) U.S. Cl. CPC G06T 7/001; G06V 10/25; H04N 1/00087; H04N 1/00018; H04N 1/00005; G06T 2207/30144

(57) ABSTRACT

For each region of interest (ROI) type of a number of ROI types, ROIs of the ROI type within a reference image are compared to corresponding ROIs within a test image corresponding to the reference image and printed by a printing device. For each ROI type, a feature vector characterizing image quality defects within the test image for the ROI type is generated based on results of the comparing for the ROI type. Whether print quality of the printing device has degraded below a specified acceptable print quality level can be assessed based on the feature vectors for the ROI types.

### BACKGROUND

Printing devices can use a variety of different technologies to form images on media such as paper. Such technologies include dry electrophotography (EP) and liquid EP (LEP) technologies, which may be considered as different types of laser and light-emitting diode (LED) printing technologies, as well as fluid-jet printing technologies like inkjet-printing technologies. Printing devices deposit print material, such as colorants like dry and liquid toner as well as printing fluids like ink, among other types of print material.

### BRIEF DESCRIPTION OF THE DRAWINGS

FIG. 1 is a flowchart of an example method for identifying the regions of interest (ROIs) within a reference image and corresponding ROIs within a test image that corresponds to the reference image.

FIGS. 2A, 2B, and 2C are diagrams of an example reference image, an example object map of the reference image, and example ROIs extracted from the example reference image based on the example object map, respectively.

FIG. 3 is a flowchart of an example method for assessing and correcting print quality degradation using feature vectors generated based on a comparison of ROIs within a reference image and corresponding ROIs within a test image that corresponds to the reference image.

FIGS. 4A and 4B are flowcharts of an example method for performing streaking and banding analyses on a test image symbol ROI, upon which basis a feature vector can be generated.

FIGS. 5A, 5B, 5C, 5D, 5E, and 5F are diagrams illustratively depicting the example performance of a portion of the method of FIGS. 4A and 4B.

FIG. 6 is a flowchart of an example method for performing symbol fading (i.e., character fading such as text fading) analysis on a test image symbol ROI, upon which basis a feature vector can be generated.

FIG. 7 is a diagram illustratively depicting the example performance of a portion of the method of FIG. 6.

FIG. 8 is a flowchart of an example method for performing color fading analysis on a test image raster ROI, upon which basis a feature vector can be generated.

FIG. 9 is a flowchart of an example method for performing streaking and banding analyses on a test image raster ROI, upon which basis a feature vector can be generated.

FIG. 10 is a flowchart of an example method for performing color fading analysis on a test image vector ROI, upon which basis a feature vector can be generated.

FIG. 11 is a flowchart of an example method for performing streaking and banding analyses on a test image vector ROI, upon which basis a feature vector can be generated.

FIG. 12 is a flowchart of an example method for performing streaking and banding analyses on a test image background ROI, upon which basis a feature vector can be generated.

FIG. 13 is a diagram of an example computer-readable data storage medium.

FIG. 14 is a diagram of an example printing device.

FIG. 15 is a flowchart of an example method.

### DETAILED DESCRIPTION

As noted in the background, printing devices can be used to form images on media using a variety of different technologies. While printing technologies have evolved over time, they are still susceptible to various print defects. Such defects may at first manifest themselves nearly imperceptibly before reaching the point at which print quality has inescapably degraded. Detecting print quality degradation before it becomes too excessive can make ameliorating the root problem less costly and time-consuming, and can also improve end user satisfaction of a printing device. Accurate identification and assessment of print quality degradation can assist in the identification of the defects responsible for and the root causes of the degradation.

Assessing degradation in the print quality of a printing device has traditionally been a cumbersome, time-consuming, and costly affair. An end user prints a specially designed test image and provides the printed image to an expert. The expert, in turn, evaluates the test image, looking for telltale signs of print defects to assess the overall degradation in print quality of the printing device. Upon locating such print defects, the expert may be able to discern the root causes of the degradation and provide solutions to resolve them. With the provided solutions in hand, the end user may thus be able to fix the problems before they become too unwieldy to correct or more severely impact print quality.

Techniques described herein, by comparison, provide for a way by which degradation in the print quality of a printing device can be assessed without having to involve an expert or other user. The techniques instead generate feature vectors that characterize image quality defects within a test image that a printing device has printed. The test image corresponds to a reference image in which regions of interest (ROIs) of different types are identified. The different types of ROIs can include raster, symbol, background, and vector ROI types, for instance. The feature vectors can be generated based on a comparison of the ROIs within the reference image and their corresponding ROIs within the test image. Whether print quality has degraded below a specified level of acceptability can be assessed based on the generated feature vectors.

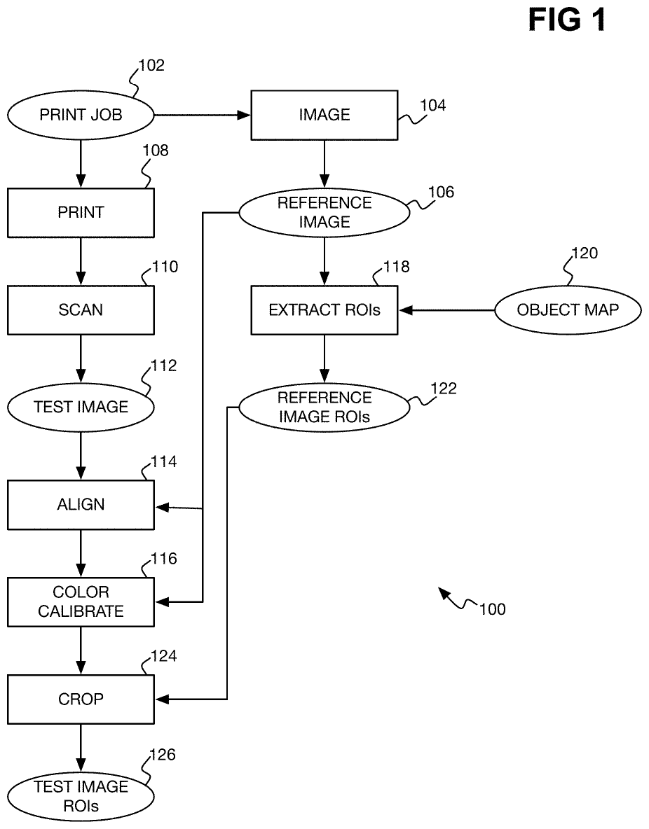

FIG. 1 shows an example method 100 for identifying the ROIs within a reference image and corresponding ROIs within a test image corresponding to the reference image, so that feature vectors characterizing image quality defects within the test image can be subsequently generated. The reference and test image ROIs can be identified, or extracted, in a manner other than the method 100. The method 100 may be implemented as program code stored on a non-transitory computer-readable data storage medium and executable by a processor. The processor may be part of a printing device like a printer, or a computing device such as a computer.

A print job 102 may include rendered data specially adapted to reveal image quality defects of a printing device when printed, or may be data submitted for printing during the normal course of usage of the device, such as by the end user, and then rendered. The print job 102 may be defined in a page description language (PDL), such as PostScript or the printer control language (PCL). The definition of the print job 102 can include text (e.g., human-readable) or binary data streams, intermixed with text or graphics to be printed. Source data may thus be rendered to generate the print job 102.

The method 100 includes imaging the print job 102 (104) to generate a reference image 106 of the job 102. Imaging the print job 102 means that the job 102 is converted to a pixel-based, or bitmap, reference image 106 having a number of pixels. The imaging process may be referred to as rasterization. The print job 102 is also printed (108) and scanned (110) to generate a test image 112 corresponding to the reference image 106. The print job 102 may be printed by a printing device performing the method 100, or by a computing device performing the method 100 sending the job 102 to a printing device. The print job 102 may be scanned using an optical scanner that may be part of the printing device or a standalone scanning device.

The method 100 includes extracting ROIs from the reference image 106 using an object map 120 for the reference image 106 (116), to generate reference image ROIs 122. The object map 120 distinguishes different types of objects within the reference image 106, and specifies the type of object to which each pixel of the image 106 belongs. Such different types of objects can include symbol objects including text and other symbols, raster images including pixel-based graphics, and vector objects including vector-based graphics. The object map 120 may be generated from the print job 102 or from the reference image 106. An example technique for generating the object map 120 from the reference image 106 is described in Z. Xiao et al., “Digital Image Segmentation for Object-Oriented Halftoning,” Color Imaging: Displaying, Processing, Hardcopy, and Applications 2016.

The reference image ROIs 122 may be extracted from the reference image 106 and the object map 120 using the technique described in the co-filed PCT patent application entitled “Region of Interest Extraction from Reference Image Using Object Map,” filed on [date] and assigned patent application No. [number]. Another such example technique is described in M. Ling et al., “Traffic Sign Detection by ROI Extraction and Histogram Features-Based Recognition,” 2013 IEEE International Joint Conference on Neural Networks. Each reference image ROI 122 is a cropped portion of the reference image 106 of a particular ROI type. There may be multiple ROIs 122 of the same ROI type. The ROIs 122 are non-overlapping, and can identify areas of the reference image 106 in which print defects are most likely to occur and/or be discerned when the image 106 is printed.

The ROI types may correspond to the different object types of the object map 120 and include symbol and raster ROI types respectively corresponding to the symbol and rater object types. In one implementation, the ROI types may thus include a vector ROI type as well, corresponding to the vector object type. In another implementation, however, there may be two ROI types corresponding to the vector object type instead of just one. The vector ROI type may itself just include uniform non-white as well as smooth gradient color areas, whereas another, background ROI type may just include uniform areas in no colorant is printed, and which thus have the color of the media.

The method 100 can include aligning the printed and scanned test image 112 with the reference image 106 (114), to correct misalignment between the test image 112 and the reference image 106. That is, upon printing and scanning, the location of each pixel within the test image 112 may differ from the location of the corresponding pixel within the reference image 106. The alignment process can include shifting the test image 112 horizontally and/or vertically, among other operations, to align the locations of the pixels in the test image 112 with their corresponding pixels in the reference image 106, within a margin of error. An example alignment technique is described in A. Myronenko et al., “Intensity-Based Image Registration by Minimizing Residual Complexity,” 2010 IEEE transactions on medical imaging, 29(11).

The method 100 can include color calibrating the aligned test image 112 against the reference image 106 (116), to correct for color variations between the test image 112 and the reference image 106. That is, upon printing and scanning, the color of each pixel within the test image 112 may vary from the color of its corresponding pixel within the reference image 106, due to the manufacturing and operational tolerances and characteristics of the printing device and/or the scanner. The color calibration process can thus modify the color of each pixel of the test image 112 so that it corresponds to the color of the corresponding pixel of the reference image 106, within a margin of error. An example color calibration technique is described in E. Reinhard et al., “Color Transfer Between Images,” 2001 IEEE Computer Graphics and Applications, 21(5).

The method 100 can include cropping the color calibrated test image 112 to generate test image ROIs 126 corresponding to the reference image ROIs 122 (124). For example, a reference image ROI 122 is a cropped portion of the reference image 106 at a particular location within the image 106 and having a particular size. As such, the corresponding test image ROI 126 is a cropped portion of the test image 112 at the same location within the image 112 and having the same particular size. There is, therefore, a one-to-one correspondence between the reference image ROIs 122 and the test image ROIs 126.

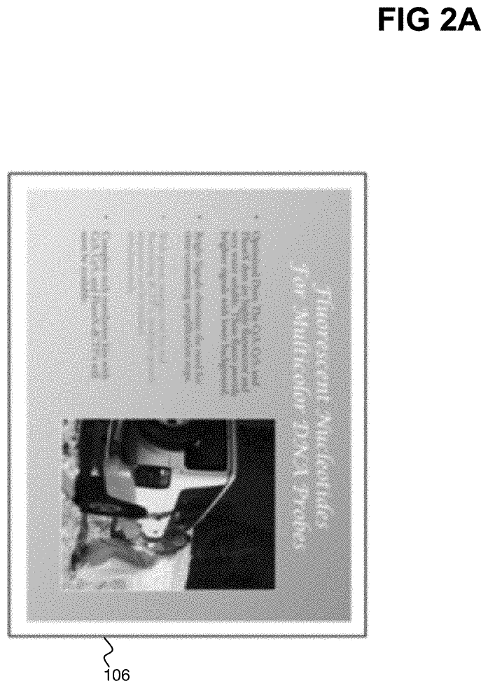

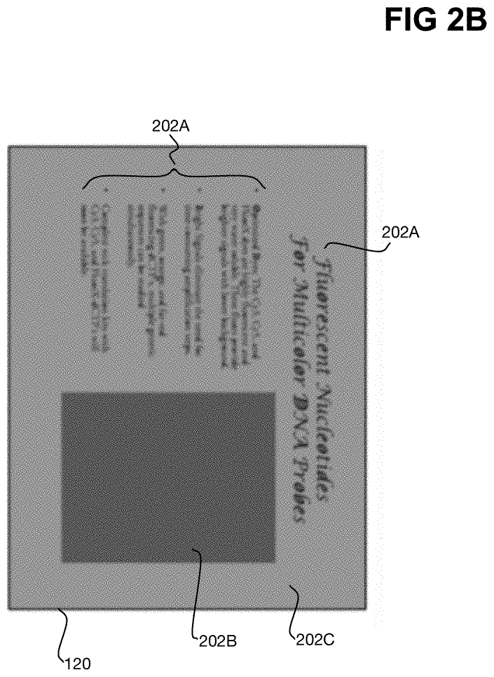

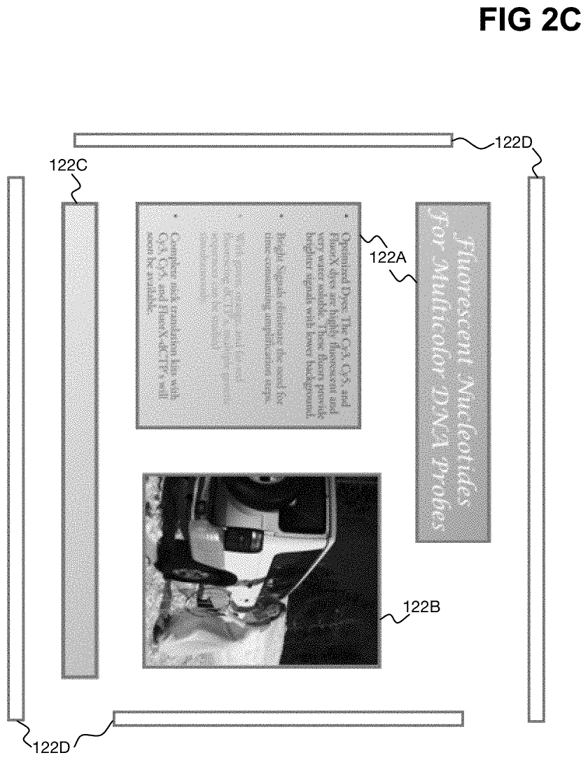

FIG. 2A shows an example reference image 106. FIG. 2B shows an example object map 120 for the reference image 106 of FIG. 2A. The object map 120 distinguishes symbol objects 202A, a raster object 202B, and a vector object 202C within the reference image 106. That is, the object map 120 specifies the assignment of each pixel of the reference image 106 to a symbol object 202A, a raster object 202B, or a vector object 202C.

FIG. 2C shows example reference image ROIs 122 extracted from the reference image 106 of FIG. 2A using the object map 120 of FIG. 2B. The reference image ROIs 122 include symbol ROIs 122A corresponding to the symbol objects 202A of the object map 120, as well as a raster ROI 122B corresponding to the raster object 202B of the map 120. The reference image ROIs further include vector ROIs 122C and background ROIs 122D that correspond to the vector object 202C of the object map 120.

The symbol ROIs 122A, the raster ROI 122B, the vector ROIs 122C, and the background ROIs 122D can collectively be referred to as the reference image ROIs 122. Each reference image ROI 122 is a cropped contiguous portion of the reference image 106 of an ROI type. The reference image ROIs 122 do not overlap one another; that is, each pixel of the reference image 106 belongs to at most one ROI 122. Whereas the object map 120 specifies the object 202 to which every pixel of the reference image 106 belongs, the reference image ROIs 122 each include just a subset of the pixels of the reference image 106. Further, not all the pixels of the reference image 106 may be included within any reference image ROI 122.

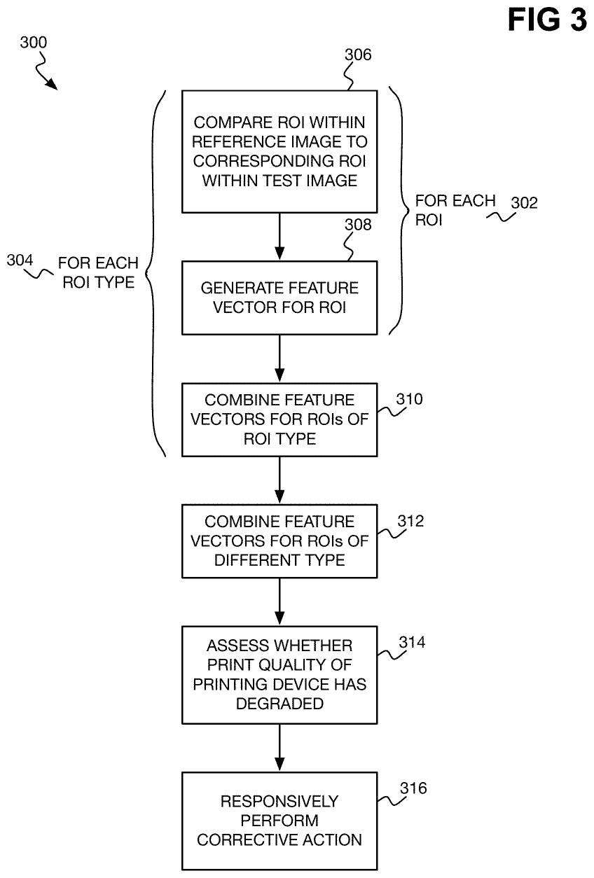

FIG. 3 shows an example method 300 for assessing and correcting print quality degradation using feature vectors generated based on a comparison of ROIs within a reference image and corresponding ROIs within a test image that corresponds to the reference image. The method 300 may be implemented at least in part as program code stored on a non-transitory computer-readable data storage medium and executed by a processor. For instance, some parts of the method 300 may be executed by (a processor of) a printing device, and other parts may be expected by (a processor of) a computing device. The computing device may be cloud-based in one implementation.

For each extracted reference image ROI 122 (302) of each ROI type (304), the method 300 includes the following. The reference image ROI 122 of an ROI type and its corresponding test image ROI 126 are compared to one another (306). Based on the results of this comparison, a feature vector is generated for the ROI (308). The feature vector characterizes image quality defects within the test image ROI 126. For each ROI type (304), the generated feature vectors for the ROIs of the ROI type in question can then be combined (e.g., concatenated or subjected to a union operation) (310), to generate a feature vector characterizing image quality defects within the test image 112 for that ROI type. The feature vectors for the different ROI types may in turn be combined to generate a single feature vector characterizing image quality defects within the test image 112 as a whole (312).

A feature vector is a vector (e.g., collection or set) of image characteristic-based values. The feature vector for each ROI type can be defined to include such image characteristic-based values that best characterize the image quality defects within the test image 112 for that ROI type. An example manner by which a reference image ROI 122 of each ROI type can be compared to its corresponding test image ROI 126 is described later in the detailed description. An example definition of the feature vector for each ROI type, and an example manner by which the feature vector can be generated based on the results of the comparison of a reference image ROI 122 of that ROI type and its corresponding test image ROI 126, are also described later in the detailed description.

In one implementation, parts 306, 308, 310, and 312 can be performed by the printing device that printed and scanned the print job 102 to generate the test image 112. In another implementation, parts 306, 308, 310, and 312 can be performed by a computing device separate from the printing device. For example, once the printing device has printed the print job 102, a scanner that is part of the printing device or part of a standalone scanning device may scan the printed print job 102 to generate the test image 112, and then the computing device may perform parts 306, 308, 310, and 312.

The method 300 can include assessing whether print quality of the printing device that printed the test image 112 has degraded below a specified acceptable print quality level (314), based on the generated feature vectors that may have been combined in part 312. Such an assessment can be performed in a variety of different ways. For example, an unsupervised or supervised machine learning technique may be employed to discern whether print quality has degraded below a specified acceptable print quality level. As another example, the generated feature vectors may be subjected to a rule-based or other algorithm to assess whether print quality has degraded below a specified acceptable print quality level. As a third example, the values within the generated feature vectors may each be compared to a corresponding threshold, and if more than a specified weighted or unweighted number of the values exceed their thresholds, then it is concluded that print quality has degraded below a specified acceptable print quality level.

The assessment of part 314 can be performed by a cloud-based computing device. For example, the combined feature vectors may be transmitted by a printing device or a computing device to another computing device over a network, such as the Internet. The latter computing device may be considered a cloud-based computing device, which performs the assessment.

The method 300 may include responsively performing a corrective action to improve the degraded print quality of the printing device (316). The corrective action may be identified based on the image quality defects within the test image that the feature vectors characterize. The corrective action may be identified by the computing device that performed the assessment of part 314, such as a cloud-based computing device, and then sent to the printing device for performance, or to another computing device more locally connected to the printing device and that can perform the corrective action on the printing device.

There may be more than one corrective action, such as a corrective action for each ROI type. The corrective actions may include reconfiguring the printing device so that when printing source data, the device is able to compensate for its degraded print quality in a way that is less perceptible in the printed output. The corrective actions may include replacing components within the printing device, such as consumable items thereof, or otherwise repairing the device to ameliorate the degraded print quality.

In one implementation, part 314 can be performed by a printing device transmitting the generated feature vectors, which may have been combined in part 312, to a computing device that performs the actual assessment. As such, the generated feature vectors of a large number of similar printing devices can be leveraged by the computing device to improve print quality degradation assessment, which is particularly beneficial in the context of a machine learning technique. In another implementation, part 314 can be performed by a computing device that also generated the feature vectors. Part 316 can be performed by or at the printing device itself. For instance, the identified corrective actions may be transmitted to the printing device for performance by the device.

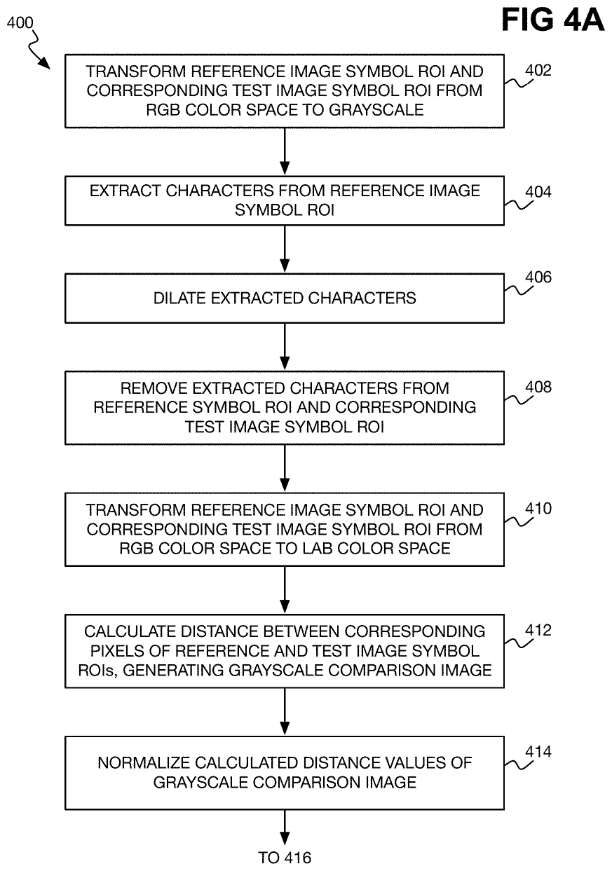

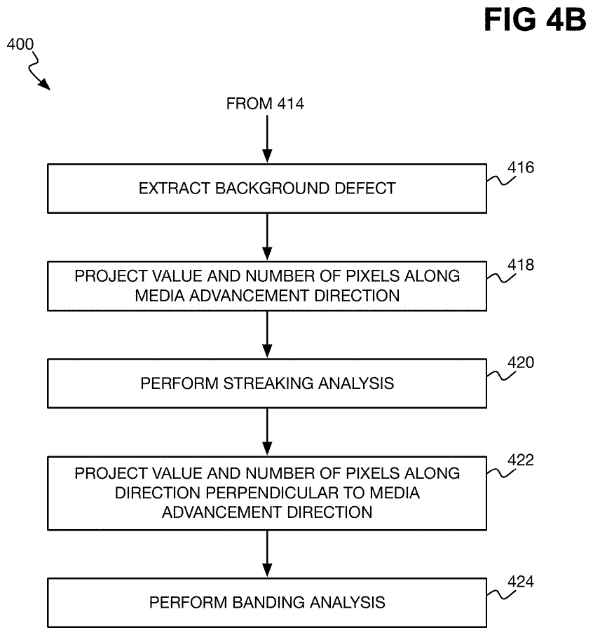

FIGS. 4A and 4B show an example method 400 for performing streaking and banding analyses on a symbol ROI 126 within a test image 112, upon which basis a feature vector for the test image symbol ROI 126 can then be generated. The method 400 can implement part 306 of FIG. 3 to compare the test image symbol ROI 126 and the corresponding symbol ROI 122 within the reference image 106 to which the test image 112 corresponds. The method 400 is performed for each test image symbol ROI 126. The method 400 may be implemented as program code stored on a non-transitory computer-readable data storage medium and executed by a processor, such as that of a computing device or that of a printing device that printed the test image 112.

The method 400 can include transforming reference and test image symbol ROIs 122 and 126 to grayscale (402). When the print job 102 of FIG. 1 is imaged or rasterized in part 104 after rendering, the resulting reference image 106 may be in the RGB (red-green-blue) color space. Likewise, when the print job 102 is printed and scanned in parts 108 and 110 after rendering, the resulting test image 112 may be in the RGB color space. This means that the reference and test image symbol ROIs 122 and 126 respectively generated in parts 124 and 118 of FIG. 1 are also in the RGB color space. Therefore, in part 402 they are transformed to grayscale.

The method 400 can include then extracting text and other symbol characters from the reference image symbol ROI 122 (404). Such extraction can be performed by using an image processing technique known as Otsu's method, which provides for automated image thresholding. Otsu's method returns a single intensity threshold that separates pixels into two classes, foreground (e.g., characters) and background (i.e., not characters).

The method 400 includes then performing the morphological operation of dilation on the characters extracted from the reference image symbol ROI 122 (406). Dilation is the process of enlarging the boundaries of regions, such as characters, within an image, such as the reference image symbol ROI 122, to include more pixels. In one implementation, for a 600-dots per inch (dpi) letter size reference image 106, the extracted characters are dilated by nine pixels.

The method 400 includes removing the dilated extracted characters from the reference image symbol ROI 122 and the test image symbol ROI 126 (408). That is, each pixel of the reference image symbol ROI 122 that is included in the dilated extracted characters has a relative location within the ROI 122, and is removed from the ROI 122. The test image ROI 126 likewise has a pixel at each such corresponding location, and is removed from the ROI 126. The result of removal of the dilated extracted characters from the reference image symbol ROI 122 and the test symbol image ROI 126 is the background areas of the ROIs 122 and ROI 126, respectively. That is, the pixels remaining within the reference image ROI 122 and the test image ROI 126 constitute the respective background areas of these ROIs 122 and 126. It is noted that the dilated extracted characters are removed from the original ROIs 122 and 126, not the grayscale versions thereof generated in part 102.

The method 400 can include then transforming reference and test image symbol ROIs 122 and 126 from which the extracted characters have been removed to the LAB color space (410). The LAB color space is also known as the L*a*b or CIELAB color space. The reference and test image symbol ROIs 122 and 126 are thus transformed from the RGB color space, for instance, to the LAB color space.

The method 400 can include calculating a distance between corresponding pixels of the reference and test image symbol ROIs 122 and 126 (412). The calculated distance may be the Euclidean distance within the LAB color space. Such a distance may be specified as ΔE_{(i,j)}={square root over ((L_{(i,j)}^{ref}−L_{(i,j)}^{test})²+(a_{(i,j)}^{ref}−a_{(i,j)}^{test})²+(b_{(i,j)}^{ref}−b_{(i,j)}^{test})²)}. In this equation, L_{(i,j)}^{ref}, a_{(i,j)}^{ref}, b_{(i,j)}^{ref} are the L, a, b color values, respectively, of the reference image symbol ROI 122 at location (i,j) within the reference image 106. Likewise, L_{(i,j)}^{ref}, a_{(i,j)}^{ref}, b_{(i,j)}^{ref} are the L, a, b color values, respectively, of the test image symbol ROI 126 at location (i,j) within the test image 112.

The result of part 412 is a grayscale comparison image. The method 400 can include normalizing the calculated distances of the grayscale comparison image (414). Normalization provides for better delineation and distinction of defects. As one example, normalization may be to an eight-bit value between 0 and 255.

The method 400 includes then extracting a background defect from the normalized gray image (416). Such extraction can be performed by again using Otsu's method. In the case of part 416, Otsu's method returns a single intensity threshold that separates defect pixels from non-defect pixels. The pixels remaining within the gray image thus constitute the background defect.

The value (i.e., the normalized calculated distance) and/or number of pixels within the background defect along a media advancement direction are projected (418). The media advancement direction is the direction of the media on which the rendered print job was advanced through a printing device during printing in part 108 prior to scanning in part 110 to generate the test image 112. Part 418 may be implemented by weighting the background defect pixels at each location along the media advancement direction by their normalized calculated distances and plotting the resulting projection over all the locations along the media advancement direction. Part 418 can also or instead be implemented by plotting a projection of the number of background defect pixels at each location along the media advancement direction.

Streaking analysis can then be performed on the resulting projection (420). Streaking is the occurrence of undesired light or dark lines along the media advancement direction. In the case of an EP printing device, streaking can occur when an intermediate transfer belt (ITB), organic photoconductor (OPC), or other components of the device become defective or otherwise suffer from operational issues. Streaking analysis identifies occurrences of streaking (i.e., streaks or streak defects) within the test image ROI 126 from the projection.

To identify streaking occurrences, a threshold may be specified to distinguish background noise within the projection from actual occurrences of streaking. The threshold may be set as the average of the projection values over the locations along the media advancement direction, plus a standard deviation of the projection values. This threshold can vary based on the streak detection result. As another example, the threshold may be the average of the projection values plus twice the standard deviation. A location along the advancement direction is identified as part of a streaking occurrence if the projection value at the location exceeds this threshold. A streak is identified for each contiguous set of such contiguous locations at which the projection values exceed the threshold.

The value (i.e., the normalized calculated distance) and/or number of pixels within the background defect along a direction perpendicular to the media advance direction are also projected (422). Part 422 may be implemented in a manner similar to part 418, by weighting the background defect pixels at each location along the direction perpendicular to the media advancement direction by their grayscale values and plotting the resulting projection over all the locations along this direction. Part 422 can also or instead be implemented by plotting a projection of the number of background defect pixels at each location along the direction perpendicular to the media advancement direction.

Banding analysis can then be performed on the resulting projection (424). Banding analysis is similar to streaking analysis. However, whereas streaks occur along the media advancement direction, bands (i.e., band defects or banding occurrences) that are identified by the banding analysis occur along the direction perpendicular to the media advancement direction. Banding is thus the occurrence of undesired light or dark lines along the direction perpendicular to the media advancement direction.

As with the identification of streaking occurrences, to identify banding occurrences a threshold may be specified to distinguish background noise within the projection from actual occurrences of banding. The threshold may be set as the average of the projection values over the locations along the direction perpendicular to the media advancement direction, plus a standard deviation. This threshold can similarly change based on the streak detection result, and as another example, can be the average of the projection values plus twice the standard deviation. A location along the direction perpendicular to the media advancement direction is identified as part of a banding occurrence if the projection value at the location exceeds this threshold. A band is identified for each contiguous set of such contiguous locations at which the projection values exceed the threshold.

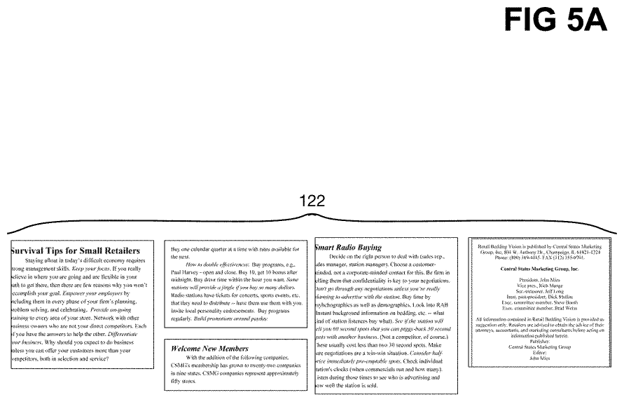

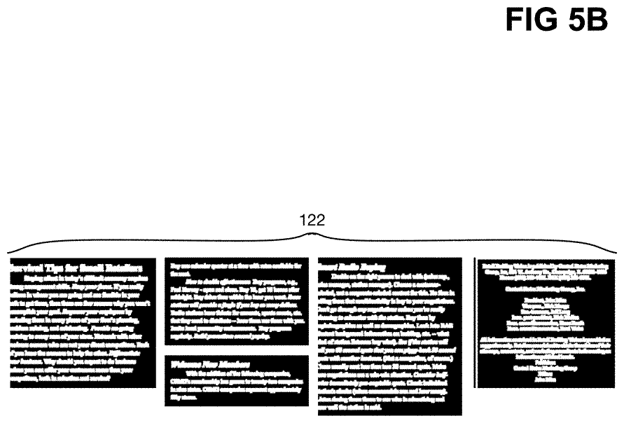

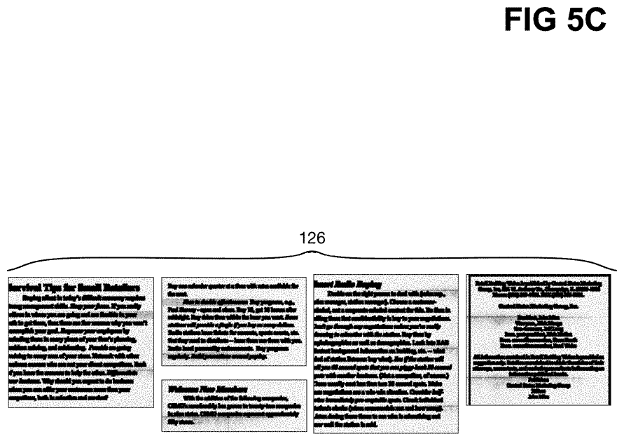

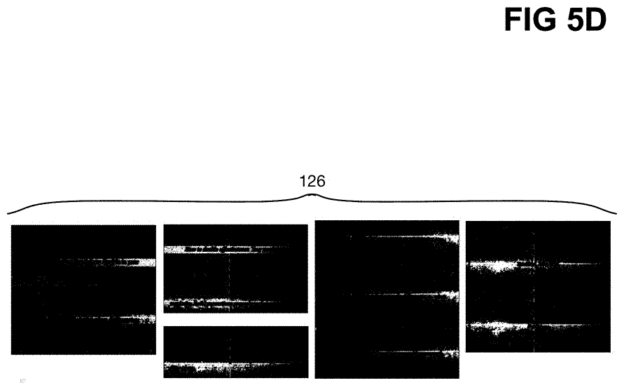

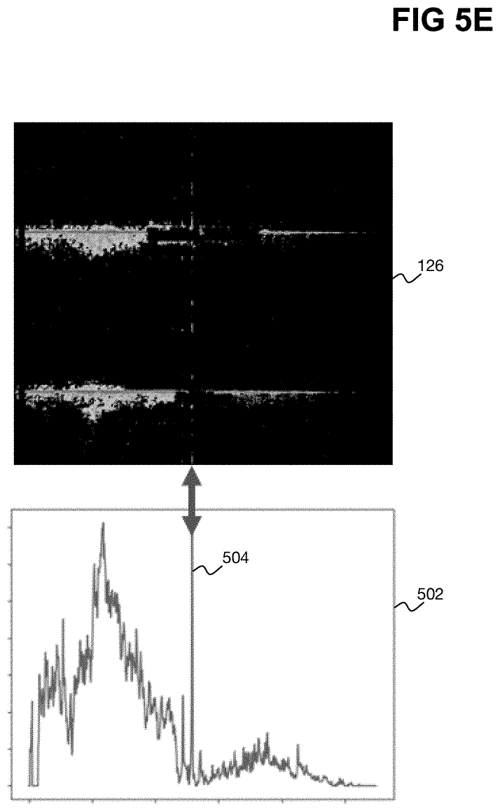

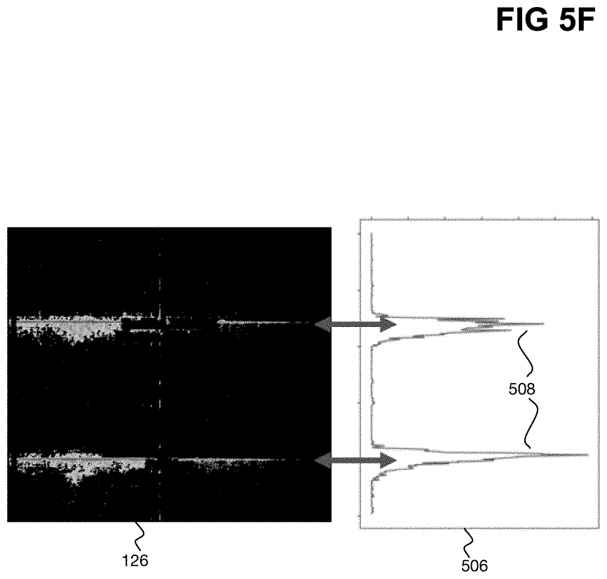

FIGS. 5A, 5B, 5C, 5D, 5E, and 5F illustratively depicting example performance of a portion of the method 400. FIG. 5A shows the characters extracted from five reference image symbol ROIs 122 that result after performing part 404. FIG. 5B shows an inverse image of the extracted characters of these reference image symbol ROIs 122 after having been dilated in part 406. FIG. 5C shows background areas of corresponding test image symbol ROIs 126 after dilated extracted characters have been removed from these ROIs 126 in part 408. FIG. 5D shows the background defects of the test image symbol ROIs 126 that result after performing part 416.

FIG. 5E shows a normalized calculated distance value projection 502 that results after performing part 418 on the background defects of the rightmost test image symbol ROI 126 of FIG. 5D. FIG. 5E also shows identification of a streak 504, resulting from performing the streaking analysis of part 420. FIG. 5F shows a normalized calculated distance value projection 506 that results after performing part 422 on the background defects of the rightmost test image symbol ROI 112 of FIG. 5D. FIG. 5F also shows identification of two bands 508, resulting from performing the banding analysis of part 424. As noted above, in addition to distance value projections, projections of the number of background defect pixels can also be generated in parts 418 and 422.

A feature vector for a test image symbol ROI 126 can be generated once the method 400 has been performed for this ROI 126. In one implementation, the feature vector includes determining the following values for inclusion within the vector. One value is the average color variation of pixels belonging to the band and streak defects identified in parts 420 and 424. The color variation of such a defect pixel can be the calculated Euclidean distance, ΔE, that has been described.

The feature vector can include values corresponding to the total number, total width, average length, and average sharpness of the streak defects identified within the test image symbol ROI 126. The width of a streak defect is the number of locations along the direction perpendicular to the media advancement direction encompassed by the defect. The length of a streak defect is the average value of the comparison image projections of the defect at these locations. The sharpness of a streak defect may in one implementation be what is referred to as the 10-90% rise distance of the defect, which is the number of pixels between the 10% and 90% gray values, where 0% is a completely black pixel and 100% is a completely white pixel.

The feature vector can similarly include values corresponding to the total number, total width, average length, and average sharpness of the band defects identified within the ROI 126. The width of a band defect is the number of locations along the media advancement direction encompassed by the defect. The length of a band defect is the average value of the comparison image projections of the defect at these locations. The sharpness of a band defect may similarly in one implementation be the 10-90% rise distance of the defect.

The feature vector can include values for each of a specified number of the streak defects, such as the three largest streak defects (e.g., the three streak defects having the greatest projections). These values can include the width, length, sharpness, and severity of each such streak defect. The severity of a streak defect may in one implementation be the average color variation of the defect (i.e., the average ΔE value) multiplied by the area of the defect.

The feature vector can similarly include values for each of a specified number of band defects, such as the three largest band defects (e.g., the three band defects having the greatest projections). These values can include the width, length, sharpness, and severity of each such band defect. The severity of a band defect may similarly in one implementation be the average color variation of the defect multiplied by the defect's area.

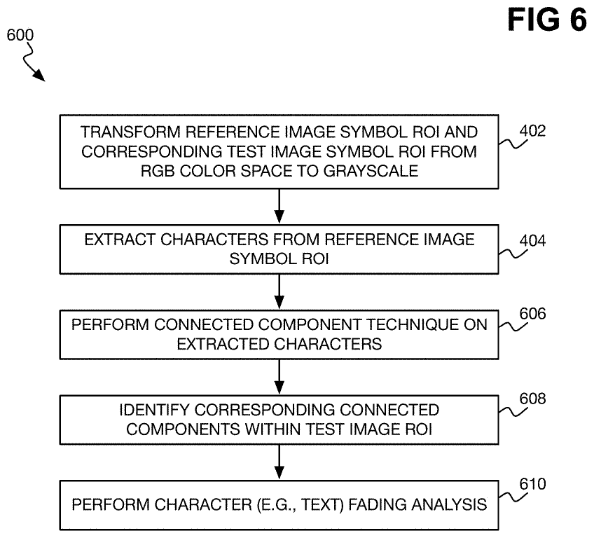

FIG. 6 shows an example method 600 for performing symbol fading (i.e., character fading such as text fading) analysis on a symbol ROI 126 within a test image 112, upon which basis a feature vector for the test image symbol ROI 126 can then be generated. The feature vector for a test image symbol ROI 126 can thus be generated based on either or both the analyses of FIGS. 5 and 6. The method 600 can therefore also implement part 306 of FIG. 3 to compare the test image symbol ROI 126 and the corresponding ROI 122 within the reference image 106 to which the test image 112 corresponds. The method 600 is performed for each test image symbol ROI 126. The method 600 can be implemented as program code stored on a non-transitory computer-readable data storage medium and executed by a processor, such as that of a computing device or that of a printing device that printed the test image 112.

As in FIG. 4, the method 600 can include transforming reference and test image symbol ROIs 122 and 126 to grayscale (402). Also as in FIG. 4, the method 600 can include extracting text and other symbol characters from the reference image symbol ROI 122 (404). The method 600 then performs a connected component technique, or algorithm, on the extracted characters (606). The connected component technique performs connected component analysis, which is a graph theory application that identifies subsets of connected components. The connected component technique is described, for instance, in H. Samet et al., “Efficient Component Labeling of Images of Arbitrary Dimension Represented by Linear Bintrees,” 1988 IEEE Transactions on Pattern Analysis and Machine Intelligence, 10(4).

In the context of the method 600, the connected component analysis assigns the pixels of the characters extracted from the reference image symbol ROI 122 to groups. The groups may, for instance, correspond to individual words, and so on, within the extracted characters. The pixels of a group are thus connected to one another to some degree; each group can be referred to as a connected component.

The method 600 includes then identifying the corresponding connected components within the test image symbol ROI 126 (608). A connected component within the test image symbol ROI 126 should be the group of pixels within the ROI 126 at the same locations as a corresponding connected component of pixels within the reference image symbol ROI 122. This is because the test image 112 has been aligned with respect to the reference image 106 in part 114 of FIG. 1, prior to the test image ROIs 126 having been generated.

However, in actuality, some misalignment may remain between the test image 112 and the reference image 106 after image alignment. This means that the group of pixels within the test image symbol ROI 126 at the same locations as a given connected component of pixels within the reference image symbol ROI 122 may not identify the same extracted characters to sufficient precision. Therefore, a cross-correlation value between the connected component of the reference image symbol ROI 122 and the groups of pixels at the corresponding positions in the test image symbol ROI 126 may be determined. The group of pixels of the test image symbol ROI 126 having the largest cross-correlation value is then selected as the corresponding connected component within the ROI 126, in what can be referred to as a template-matching technique.

However, if the cross-correlation value of the selected group is lower than a threshold, such as 0.9, then the connected component in question is discarded and not considered further in the method 600. Furthermore, in one implementation, the results of the connected component analysis performed in part 606 and the identification performed in part 608 can be used in lieu of the morphological dilation of part 406 in FIG. 4. In such an implementation, the connected components identified within the test image symbol ROI 126 are removed from this ROI 126 in part 408, instead of the characters extracted from the reference image symbol ROI 122 after dilation.

As a rudimentary example of part 608, five groups of pixels of the test image symbol ROI 126 may be considered. The first group is the group of pixels within the test image symbol ROI 126 at the same locations as the connected component of pixels within the reference image symbol ROI 122. The second and third groups are groups of pixels within the test image symbol ROI 126 at locations respectively shifted one pixel to the left and the right relative to the connected component of pixels within the reference image symbol ROI 122. The fourth and fifth groups are groups of pixels within the test image symbol ROI 126 at locations respectively shifted one pixel up and down relative to the connected component of pixels within the reference image symbol ROI 122.

The cross-correlation value may be determined as:

$${R}_{corr} = \frac{{\sum }_{{x}^{′} , {y}^{′}} T ( {x}^{′} , {y}^{′} ) ▯ / ( x + {x}^{′} , y + {y}^{′} )}{\sqrt{{\sum }_{{x}^{′} , {y}^{′}} {T ( {x}^{′} , {y}^{′} )}^{2} ▯ {\sum }_{{x}^{′} , {y}^{′}} / {( x + {x}^{′} , y + {y}^{′} )}^{2}}}$$

In this equation, R_{corr} is the cross-correlation value. The value T(x′,y′) is the value of the pixel of the reference image symbol ROI 122 at location (x′,y′) within the reference image 106. The value I(x+x′,y+y′) is the value of the pixel of the test image symbol ROI 126 at location (x+x′,y+y′) within the reference image 112. The values X and y represent the amount of shift in the x and y directions, respectively.

The method 600 includes performing symbol fading (i.e., character fading such as text fading) analysis on the connected components identified within the test image symbol ROI 126 in relation to their corresponding connected components within the reference image symbol ROI 122 (610). The fading analysis is a comparison of each connected component of the test image symbol ROI 126 and its corresponding connected component within the reference image symbol ROI 122. Specifically, various values and statistics may be calculated. The comparison of a connected component of the test image symbol ROI 126 and the corresponding connected component of the reference image symbol ROI 122 (i.e., the calculated values and statistics) characterizes the degree of fading, within the test image 112, of the characters that the connected component identifies.

A feature vector for the test image symbol ROI 126 can be generated once the method 600 has been performed. The generated feature vector can include the calculated values and statistics. Three values may be the average L, a, and b color channel values of pixels of the connected components within the reference test image symbol ROI 122. Similarly, three values may be the average L, a, and b color channel values of pixels of the corresponding connected components within the test image symbol ROI 126.

Two values of the feature vector may be the average color variation and the standard deviation thereof between the pixels of the connected components within the reference image symbol ROI 122 and white. The color variation between such a pixel and the color white can be the ΔE_{(i,j)} value described above in relation to part 412 of FIG. 4, but where L_{(i,j)}^{test}, a_{(i,j)}^{test}, b_{(i,j)}^{test} are replaced by the values (100, 0, 0), which define white.

Similarly, two values may be the average color variation and the standard deviation thereof between the pixels of the connected components within the test image symbol ROI 126 and white. The color variation between such a pixel and the color white can be the ΔE_{(i,j)} value described above in relation to part 412 of FIG. 4, but where L_{(i,j)}^{ref}, a_{(i,j)}^{ref}, b_{(i,j)}^{ref} are replaced by the values 100, 0, 0, which define white.

Two values of the feature vector may be the average color variation and the standard deviation thereof between the pixels of the connected components within the test image symbol ROI 126 and the pixels of the connected components within the reference image symbol ROI 122. The color variation between a pixel of the connected component within the test image symbol ROI 126 and the pixels of the corresponding connected component within the reference image symbol ROI 122 can be the ΔE_{(i,j)} value described above in relation to part 412 of FIG. 4.

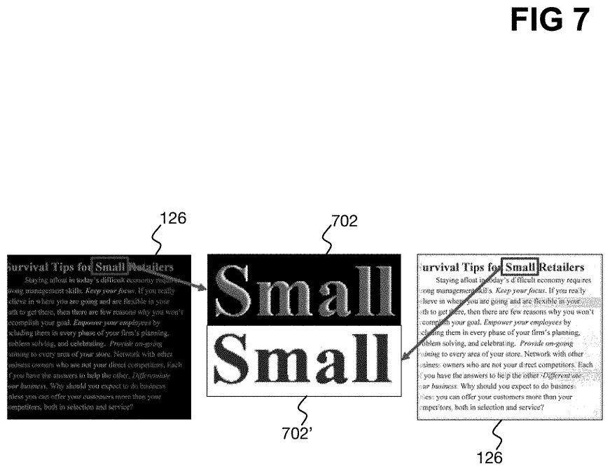

FIG. 7 illustratively depicts an example performance of a portion of the method 600. FIG. 7 specifically shows on the right side a test image symbol ROI 126, and an inverse image of the test image symbol ROI 126 on the left side. The connected component 702 that has been initially identified within the test image symbol ROI 126 as corresponding to the connected component for the word “Small” within a corresponding reference image symbol ROI shows a slight mismatch as to this word. However, by using the template-matching technique described in relation to part 608, the connected component within the test image symbol ROI 106 that more accurately corresponds to the connected component for the word “Small” within the reference image symbol ROI can be identified. This more accurately matched connected component is referenced as the connected component 702′ in FIG. 7, and has the largest cross-correlation value.

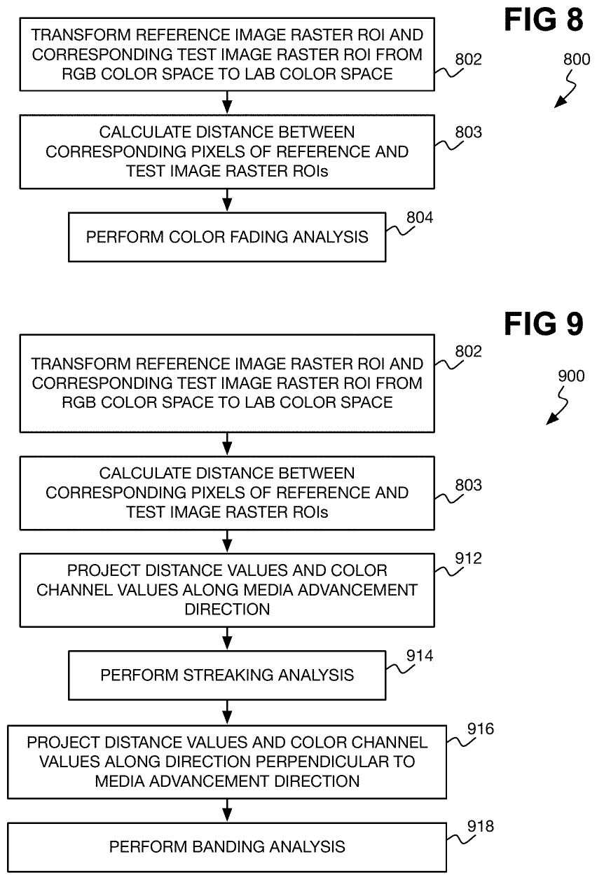

FIG. 8 shows an example method 800 for performing color fading analysis on a raster ROI 126 within a test image 112, upon which basis a feature vector for the test image raster ROI 126 can then be generated. The method 800 can implement part 306 of FIG. 3 to compare each test image raster ROI 126 and its corresponding ROI 122 within the reference image 106. The method 800 is performed for each test image raster ROI 126. The method 800 can be implemented as program code stored on a non-transitory computer-readable data storage medium and executed by a processor, such as that of a computing device or that of a printing device that printed the test image 112.

The method 800 can include transforming reference and test image raster ROIs 122 and 126 to the LAB color space (802). The method 800 can include calculating a distance between corresponding pixels of the reference and test image raster ROIs 122 and 126 (803). The calculated distance may be the Euclidean distance within the LAB color space, such as the ΔE_{(i,j)} value described above in relation to part 412 of FIG. 4. The method 800 includes then performing color fading analysis on the test image raster ROI 126 in relation to the reference image raster ROI 122 (804). Specifically, various values and statistics may be calculated. The comparison of the test image raster ROI 126 to the reference image raster ROI 122 (i.e., the calculated values and statistics) characterizes the degree of color fading within the test image raster ROI 126.

A feature vector for the test image raster ROI 126 can be generated once the method 800 has been performed. The generated feature vector can include the calculated values and statistics. Six such values may be the average L, a, and b color channel values, and respective standard deviations thereof, of the pixels within the reference image raster ROI 122. Similarly, six values may be the average L, a, and b color channel values, and respective standard deviations thereof, of the pixels within the test image raster ROI 126.

Two values of the feature vector may be the average color variation and the standard deviation thereof between pixels within the test image raster ROI 126 and pixels within the reference image raster ROI 122. The color variation between a pixel of test image raster ROI 126 and the pixels of the reference image raster ROI 122 can be the ΔE_{(i,j)} value described above in relation to part 412 of FIG. 4.

FIG. 9 shows an example method 900 for performing streaking and banding analyses on a raster ROI 126 within a test image 112, upon which basis a feature vector can be generated. The feature vector for a test image raster ROI 126 can thus be generated based on either or both the analyses of FIGS. 8 and 9. The method 900 can therefore implement part 306 of FIG. 3 to compare each test image raster ROI 126 and the corresponding ROI 122 within the reference image 106. The method 900 is performed for each test image raster ROI 126. The method 900 can be implemented as program code stored on a non-transitory computer-readable data storage medium and executed by a processor, such as that of a computing device or that of a printing device that printed the test image 112.

As in FIG. 8, the method 900 can include transforming reference and test image raster ROIs 122 and 126 to the LAB color space (802), and calculating a distance between each pair of corresponding pixels of the reference and test image raster ROIs 122 and 126 (803). The distance values and color channel values, such as the L color channel values, within the test image raster ROI 126 are projected along a media advancement direction (912), similar to part 418 of FIG. 4. The color variation or distance value (i.e., ΔE) projection is as in part 418. As to the L color channel value projection—as opposed to the number of pixels projection of part 418-part 912 may be implemented by weighting the pixels of the test image raster ROI 126 at each location along the media advancement direction by their L color channel values, and plotting the resulting projection over all the locations along the media advancement direction.

Streaking analysis can then be performed on the resulting projection (914), similar to part 420 of FIG. 4. As such, a threshold may be specified to distinguish background noise within the projection from actual occurrences of streaking. The threshold may be set as the average of the projection values over the locations along the media advancement direction, plus a standard deviation of the projection values. A location along the advancement direction is identified as part of a streaking occurrence if the projection value at the location exceeds this threshold. A streak defect is identified for each contiguous set of such contiguous locations at which the projection values exceed the threshold.

The distance values and color channel values, such as the L color channel values, within the test image raster ROI 126 are also projected along a direction perpendicular to the media advancement direction (916), similar to part 422 of FIG. 4. The color variation or distance value (i.e., ΔE) projection is as in part 424. As to the L color channel value projection—as opposed to the number of pixels projection of part 422-part 916 may be implemented by weighting the pixels of the test image raster ROI 126 at each location along the direction perpendicular to the media advancement direction by their L color channels, and plotting the resulting projection over all the locations along the direction perpendicular to the media advancement direction.

Banding analysis can then be performed on the resulting projection (918), similar to part 424 of FIG. 4. As such, a threshold may be specified to distinguish background noise within the projection from actual occurrences of banding. The threshold may be set as the average of the projection values over the locations along the direction perpendicular to the media advancement direction, plus a standard deviation of the projection values. A location along the direction perpendicular to the advancement direction is identified as part of a banding occurrence if the projection value at the location exceeds this threshold. A band defect is identified for each contiguous set of such contiguous locations at which the projection values exceed the threshold.

A feature vector for the test image raster ROI 126 can be generated once the method 900 has been performed for this ROI 126. The feature vector can include determining the following values for inclusion within the vector. One value is the average color variation of pixels belonging to the band and streak defects identified in parts 914 and 918. The color variation of such a defect pixel can be determined as has been described in relation to the generation of a feature vector for a test image symbol ROI 126 subsequent to performance of the method 400 of FIG. 4.

The feature vector can include two values corresponding to the average difference in L channel values, and a standard deviation thereof, of pixels within the test image raster ROI 126 and their corresponding pixels within the reference image raster ROI 122. The feature vector can include two values corresponding to the average difference in L channel values, and a standard deviation thereof, of pixels within each streak defect identified within the test image raster ROI 126 and their corresponding pixels within the reference image raster ROI 122. The feature vector can similarly include two values corresponding to the average difference in L channel values, and a standard deviation thereof, of pixels within each band defect identified within the test image raster ROI 126 and their corresponding pixels within the reference image raster ROI 122.

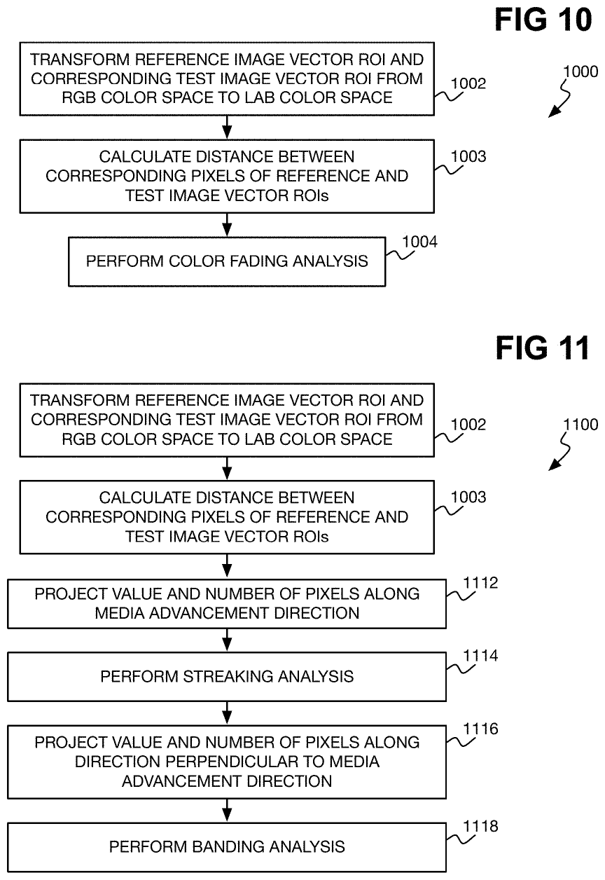

FIG. 10 shows an example method 1000 for performing color fading analysis on a vector ROI 126 within a test image 112, upon which basis a feature vector can be generated for the test image vector ROI 126. The method 1000 can implemented part 306 of FIG. 3 to compare each test image vector ROI 126 and its corresponding ROI 122 within the reference image 106. The method 1000 is performed for each test image vector ROI 126. The method 1000 can be implemented as program code stored on a non-transitory computer-readable data storage medium and executed by a processor, such as that of a computing device or that of a printing device that printed the test image 112.

The method 1000 can include transforming reference and test image vector ROIs 122 and 126 to the LAB color space (1002). The method 1000 can include calculating a distance between corresponding pixels of the reference and test image vector ROIs 122 and 126 (1003). The calculated distance may be the Euclidean distance within the LAB color space, such as the ΔE_{(i,j)} value described above in relation to part 412 of FIG. 4. The method 1000 includes then performing color fading analysis on the test image vector ROI 126 in relation to the reference image vector ROI 122. Specifically, various values and statistics may be calculated. The comparison of the test image vector ROI 126 to the reference image vector ROI 122 (i.e., the calculated values and statistics) characterize the degree of color fading within the test image vector ROI 126.

A feature vector for the test image vector ROI 126 can be generated once the method 1000 has been performed. The generated feature vector can include the calculated values and statistics. Six such values may be the average L, a, and b color channel values, and respective standard deviations thereof, of pixels within the reference image vector ROI 122. Similarly, six values may be the average L, a, and b color channel values, and respective standard deviations thereof, of pixels within the test image vector ROI 126. Two values may be the average color variation and the standard deviation thereof between pixels within the test image vector ROI 126 and pixels within the reference image vector ROI 122. The color variation between a pixel of test image vector ROI 126 and the pixels of the reference image vector ROI 122 can be determined as has been described above in relation to generation of a feature factor for a test image raster ROI 126 subsequent to performance of the method 800 of FIG. 8.

FIG. 11 shows an example method 1100 for performing streaking and banding analyses on a vector ROI 126 within a test image 112, upon which basis a feature vector can be generated. The feature vector for a test image vector ROI 126 can thus be generated based on either or both the analyses of FIGS. 10 and 11. The method 1100 can therefore implement part 306 of FIG. 3 to compare each test image vector ROI 126 and its corresponding ROI 122 within the reference image 106. The method 1100 is performed for each test image vector ROI 126. The method 1100 can be implemented as program code stored on a non-transitory computer-readable data storage medium and executed by a processor, such as that of a computing device or that of a printing device that printed the test image 112.

As in FIG. 10, the method 1100 can include transforming reference and test image vector ROIs 122 and 126 to the LAB color space (1002), and calculating a distance between each pair of corresponding pixels of the reference and test image vector ROIs 122 and 126 (1003). The value (i.e., the calculated distance) and/or number of pixels within the test image vector ROI 126 are projected along a media advancement direction (1112), as in part 418 of FIG. 4. Streaking analysis can then be performed on the resulting projection (1114), as in part 420 of FIG. 4. The value (i.e., the calculated distance) and/or number of pixels within the test image vector ROI 126 are also projected along a direction perpendicular to the media advancement direction (1116), as in part 422 of FIG. 4. Banding analysis can then be performed on the resulting projection (1118), as in part 424 of FIG. 4.

A feature vector for the test image vector ROI 126 can be generated once the method 1100 has been performed for this ROI 126. The feature vector can include determining the following values for inclusion within the vector. One such value is the average color variation of pixels belonging to the band and streak defects identified in parts 1114 and 1118. The color variation of such a defect pixel can be determined as has been described in relation to the generation of a feature vector for a test image symbol ROI 126 subsequent to performance of the method 400 of FIG. 4.

The feature vector can include two values corresponding to the average difference in L channel values, and a standard deviation thereof, of pixels within the test image vector ROI 126 and their corresponding pixels within the reference image vector ROI 122. The feature vector can include two values corresponding to the average difference in L channel values, and a standard deviation thereof, of pixels within each streak defect identified within the test image vector ROI 126 and their corresponding pixels within the reference image vector ROI 122. The feature vector can similarly include two values corresponding to the average difference in L channel values, and a standard deviation thereof, of pixels within each band defect identified within the test image vector ROI 126 and their corresponding pixels within the reference image vector ROI 122.

The feature vector can also include a value corresponding to the highest-frequency energy of each streak defect identified within the test image vector ROI 126, as well as a value corresponding to the highest-frequency energy of each band defect identified within the test image vector ROI 126. The highest-frequency energy of such a defect is the value of the defect at its point of highest frequency, which can itself be determined by subjecting the defect to a one-dimensional fast Fourier transform (FFT).

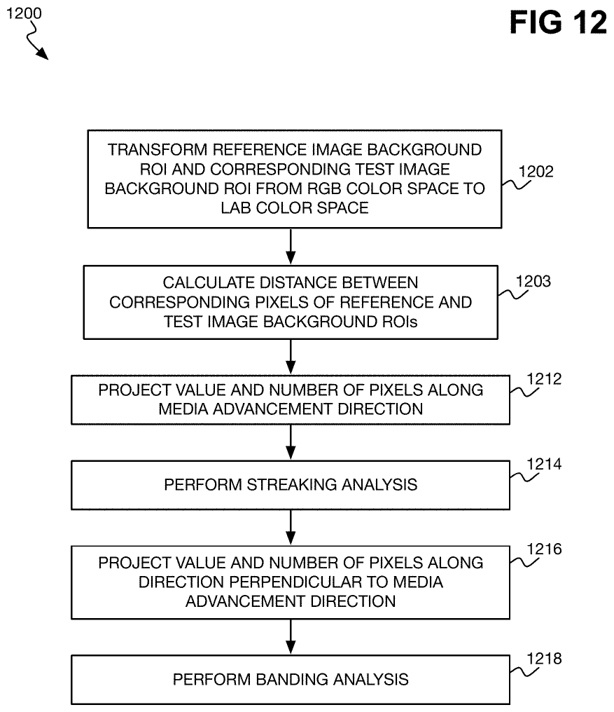

FIG. 12 shows an example method 1200 for performing streaking and banding analyses on a background ROI 126 within a test image 112, upon which basis a feature vector can be generated. The feature vector for a test image background ROI 126 can thus be generated based on the analyses of FIG. 12. The method 1200 can therefore implement part 306 of FIG. 3 to compare each test image background ROI 126 and its corresponding ROI 122 within the reference image 106. The method 1200 is performed for each test image background ROI 126. The method 1200 can be implemented as program code stored on a non-transitory computer-readable data storage medium and executed by a processor, such as that of a computing device or that of a printing device that printed the test image 112.

The method 1200 can include transforming reference and test image background ROI s 122 and 126 to the LAB color space (1202). The method 1000 can include calculating a distance between corresponding pixels of the reference and test image background ROIs 122 and 126 (1003). The calculated distance may be the Euclidean distance within the LAB color space, such as the ΔE_{(i,j)} value described above in relation to part 412 of FIG. 4. The value (i.e., the calculated distance) and/or number of pixels within the test image background ROI 126 are projected along a media advancement direction (1212), as in part 418 of FIG. 4. Streaking analysis can then be performed on the resulting projection (1214), as in part 420 of FIG. 4. The value (i.e., the calculated distance) and/or number of pixels within the test image background ROI 126 are also projected along a direction perpendicular to the media advancement direction (1216), as in part 422 of FIG. 4. Banding analysis can then be performed on the resulting projection (1218), as in part 424 of FIG. 4.

A feature vector for the test image background ROI 126 can be generated once the method 1200 has been performed for this ROI 126. The feature vector can include determining the following values for inclusion within the vector. One such value is the average color variation of pixels belonging to the band and streak defects identified in parts 1114 and 1118. The color variation of such a defect pixel can be determined as has been described in relation to the generation of a feature vector for a test image symbol ROI 126 subsequent to performance of the method 400 of FIG. 4. The feature vector can include two values corresponding to the average difference in L channel values, and a standard deviation thereof, of pixels within the test image background ROI 126 and their corresponding pixels within the reference image background ROI 122.

The feature vector can include two values corresponding to the average difference in L channel values, and a standard deviation thereof, of pixels within each streak defect identified within the test image background ROI 126 and their corresponding pixels within the reference image background ROI 122. The feature vector can similarly include two values corresponding to the average difference in L channel values, and a standard deviation thereof, of pixels within each band defect identified within the test image background ROI 126 and their corresponding pixels within the reference image background ROI 122. The feature vector can also include a value corresponding to highest-frequency energy of each streak and band defect identified within the test image background ROI 126, as has been described in relation to generation of a feature vector for a vector ROI 126 subsequent to performance of the method 1100 of FIG. 11.

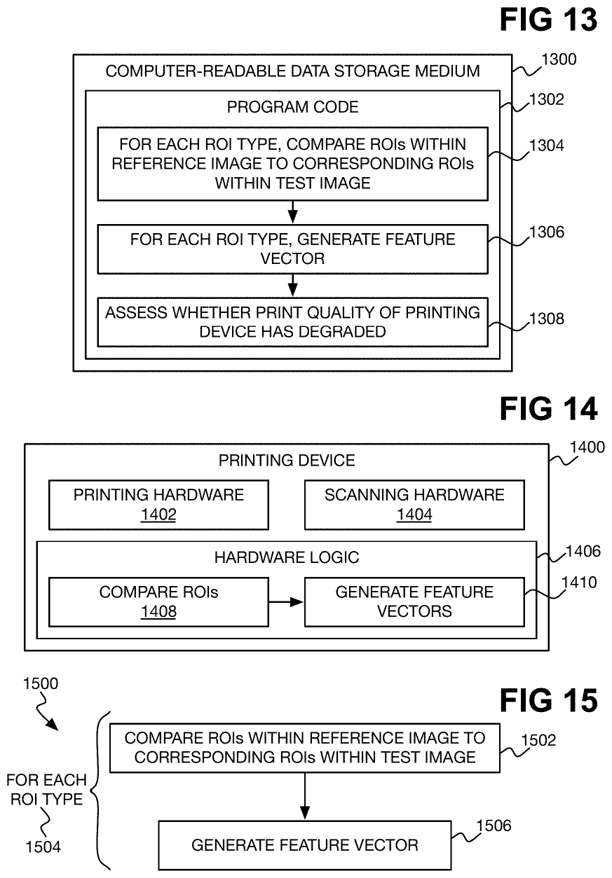

FIG. 13 shows an example computer-readable data storage medium 1300. The computer-readable data storage medium 1400 stories program code 1302. The program code 1302 is executable by a processor, such as that of a computing device or a printing device, to perform processing.

The processing includes, for each of a number of ROI types, comparing ROIs of the ROI type within a reference image to corresponding ROIs within a test image corresponding to the reference image and printed by a printing device (1304). The processing includes, for each ROI type, generating a feature vector characterizing image quality defects within the test image for the ROI type, based on results of the comparing for the ROI type (1306). The processing includes assessing whether print quality of the printing device has degraded below a specified acceptable print quality level, based on the feature vectors for the ROI types (1308).

FIG. 14 shows an example printing device 1400. The printing device 1400 includes printing hardware 1402 to print a test image corresponding to a reference image having ROIs of a number of ROI types. For example, in the case of an EP printing device, the printing hardware may include those components, such as the OPC, ITB, rollers, a laser or other optical discharge source, and so on, that cooperate to print images on media using toner. The printing device 1400 includes scanning hardware 1404 to scan the printed test image. The scanning hardware 1404 may be, for instance, an optical scanning device that outputs differently colored light onto the printed test image and detects the colored light as responsively reflected by the image.

The printing device 1400 includes hardware logic 1406. The hardware logic 1406 may be a processor and a non-transitory computer-readable data storage medium storing program code that the processor executes. The hardware logic 1406 compares the ROIs of each ROI type within the reference image to corresponding ROIs within the scanned test image (1408). The hardware logic 1406 generates, based on results of the comparing, a feature vector characterizing image quality defects within the test image for the ROI type (1410). Whether print quality of the printing device has degraded below a specified acceptable print quality level is assessable based on the generated feature vector.

FIG. 15 shows an example method 1500. The method 1500 is performed by a processor, such as that of a computing device or a printing device. The method 1500 includes comparing ROIs within a reference image to corresponding ROIs within a test image corresponding to the reference image and printed by a printing device (1502), for each of a number of ROI types (1504). The method 1500 also includes generating a feature vector characterizing image quality defects within the test image, based on results of the comparing (1506), for each ROI type (1504). Whether print quality of the printing device has degraded below a specified acceptable print quality level is assessable based on the generated feature vectors.

The techniques that have been described herein thus provide a way by which degradation in the print quality of a printing device can be assessed in an automated manner. Rather than having an expert or other user inspect a printed test image to assess print quality degradation, feature vectors are generated for ROIs identified within the printed test image. The feature vectors are generated by comparing the test image ROIs with corresponding ROIs within a reference image to which the test image corresponds. The feature vectors include particularly selected values and statistics that have been novelly determined to optimally reflect, denote, or indicate image quality defects for respective ROI types. Print quality degradation can thus be accurately assessed, in an automated manner, based on the generated feature vectors.

We claim:

1. A non-transitory computer-readable data storage medium storing program code executable by a processor to perform processing comprising:
for each region of interest (ROI) type of a plurality of ROI types, comparing ROIs of the ROI type within a reference image to corresponding ROIs within a test image corresponding to the reference image and printed by a printing device;
for each ROI type, generating a feature vector characterizing image quality defects within the test image for the ROI type, based on results of the comparing for the ROI type; and
assessing whether print quality of the printing device has degraded below a specified acceptable print quality level, based on the feature vectors for the ROI types.

2. The non-transitory computer-readable data storage medium of claim 1, wherein the processing further comprises:
responsive to assessing that the print quality of the printing device has degraded below the specified acceptable print quality level, performing a correction action at the printing device to improve the degraded print quality.

3. The non-transitory computer-readable data storage medium of claim 1, wherein the ROI types comprise a symbol ROI type, the ROIs of the symbol ROI type comprising symbols and text.

4. The non-transitory computer-readable data storage medium of claim 3, wherein comparing the ROIs of the symbol ROI type within the reference image to the corresponding ROIs within the test image comprises, for each ROI of the symbol ROI type:
performing a streaking analysis of the test image relative to the master image along a media advancement direction in which media advances through the printing device during printing; and
performing a banding analysis of the test image relative to the master image along a direction perpendicular to the media advancement direction,
and wherein generating the feature vector characterizing the image quality defects within the test image for the symbol ROI type comprises, for each ROI of the symbol ROI type, determining as values within the feature vector for the symbol ROI type:
an average color variation of pixels of band defects and streak defects within the test image, based on the performed streaking and banding analyses;
a total number, total width, average length, and average sharpness of the streak defects within the test image, based on the streaking analysis;
a total number, total width, average length, and average sharpness of the band defects within the test image, based on the banding analysis;
for each of a specified number of the streak defects within the test image, a width, length, sharpness, and severity of the streak defect within the test image, based on the streaking analysis; and
for each of a specified number of the band defects within the test image, a width, length, sharpness, and severity of the band defects within the test image, based on the band analysis.

5. The non-transitory computer-readable data storage medium of claim 3, wherein comparing the ROIs of the symbol ROI type within the reference image to the corresponding ROIs within the test image comprises, for each ROI of the symbol ROI type:
performing a symbol fading analysis of the test image relative to the master image,
and wherein generating the feature vector characterizing the image quality defects within the test image for the symbol ROI type comprises, for each ROI of the symbol ROI type, determining as values within the feature vector for the symbol ROI type:
average color channel values of symbols within the master image, based on the performed symbol fading analysis;
average color channel values of symbols within the test image, based on the performed symbol fading analysis;
statistics regarding color variation between pixels of the symbols within the master image and white, based on the performed symbol fading analysis;
statistics regarding color variation between pixels of the symbols within the test image and white, based on the performed symbol fading analysis; and
statistics regarding color variation between the pixels of the symbols within the master image and the pixels of the symbols within the test image, based on the performed symbol fading analysis.

6. The non-transitory computer-readable data storage medium of claim 1, wherein the ROI types comprise a raster ROI type, the ROIs of the raster ROI type comprising pixel-based graphics.

7. The non-transitory computer-readable data storage medium of claim 6, wherein comparing the ROIs of the raster ROI type within the reference image to the corresponding ROIs within the test image comprises, for each ROI of the raster ROI type:
performing a streaking analysis of the test image relative to the master image along a media advancement direction in which media advances through the printing device during printing; and
performing a banding analysis of the test image relative to the master image along a direction perpendicular to the media advancement direction,
and wherein generating the feature vector characterizing the image quality defects within the test image for the raster ROI type comprises, for each ROI of the raster ROI type, determining as values within the feature vector for the raster ROI type:
an average color variation of pixels of band defects and streak defects within the test image relative to the master image, based on the performed streaking and banding analyses;
statistics regarding differences between color channel values of a specified color channel of the ROI within the master image and color channel values of the specified color channel of the ROI within the test image, based on the performed streaking and banding analyses;
statistics regarding differences between color channel values of the specified color channel of the streak defects within the test image relative to the master image, based on the performed streaking analysis; and
statistics regarding differences between color channel values of the specified color channel of the band defects within the test image relative to the master image, based on the performed banding analysis.

8. The non-transitory computer-readable data storage medium of claim 6, wherein comparing the ROIs of the raster ROI type within the reference image to the corresponding ROIs within the test image comprises, for each ROI of the raster ROI type:
performing a color fading analysis of the test image relative to the master image,
and wherein generating the feature vector characterizing the image quality defects within the test image for the raster ROI type comprises, for each ROI of the raster ROI type, determining as values within the feature vector for the raster ROI type:
statistics regarding color channel values of the ROI within the master image, based on the performed color fading analysis;
statistics regarding color channel values of the ROI within the test image, based on the performed color fading analysis; and
statistics regarding color variation between the color channel values of the ROI within the master image and the color channel values of the ROI within the test image, based on the performed color fading analysis.

9. The non-transitory computer-readable data storage medium of claim 1, wherein the ROI types comprise a vector ROI type, the ROIs of the vector ROI type comprising uniform non-white and smooth gradient color areas.

10. The non-transitory computer-readable data storage medium of claim 9, wherein comparing the ROIs of the vector ROI type within the reference image to the corresponding ROIs within the test image comprises, for each ROI of the vector ROI type:
performing a streaking analysis of the test image relative to the master image along a media advancement direction in which media advances through the printing device during printing; and
performing a banding analysis of the test image relative to the master image along a direction perpendicular to the media advancement direction,
and wherein generating the feature vector characterizing the image quality defects within the test image for the vector ROI type comprises, for each ROI of the vector ROI type, determining as values within the feature vector for the vector ROI type:
an average color variation of pixels of band defects and streak defects within the test image relative to the master image, based on the performed streaking and banding analyses;
statistics regarding color variation between color channel values of a specified color channel of the ROI within the master image and color channel values of the specified color channel of the ROI within the test image, based on the color fading analysis;
statistics regarding color variation between color channel values of the specified color channel of the streak defects within the test image relative to the master image, based on the performed streaking analysis; and
statistics regarding color variation between color channel values of the specified color channel of the band defects within the test image relative to the master image, based on the performed banding analysis.

11. The non-transitory computer-readable data storage medium of claim 10, wherein generating the feature vector characterizing the image quality defects within the test image for the vector ROI type further comprises, for each ROI of the vector ROI type, determining as the values within the feature vector for the vector ROI type:
an energy at a highest frequency of each band defect; and
an energy at a highest frequency of each streak defect.

12. The non-transitory computer-readable data storage medium of claim 9, wherein comparing the ROIs of the vector ROI type within the reference image to the corresponding ROIs within the test image comprises, for each ROI of the vector ROI type:
performing a color fading analysis of the test image relative to the master image,
and wherein generating the feature vector characterizing the image quality defects within the test image for the vector ROI type comprises, for each ROI of the vector ROI type, determining as values within the feature vector for the vector ROI type:
statistics regarding color channel values of the ROI within the master image, based on the performed color fading analysis;
statistics regarding color channel values of the ROI within the test image, based on the performed color fading analysis; and
statistics regarding color variation between the color channel values of the ROI within the master image and the color channel values of the ROI within the test image, based on the performed color fading analysis.

13. The non-transitory computer-readable data storage medium of claim 9, wherein the ROI types further comprise a background ROI type, the ROIs of the background ROI type comprising uniform white color areas.

14. A printing device comprising:
printing hardware to print a test image corresponding to a reference image having regions of interest (ROIs) of a plurality of ROI types;
scanning hardware to scan the printed test image; and
hardware logic to:
compare the ROIs of each ROI type within the reference image to corresponding ROIs within the scanned test image; and
generate based on results of the comparing a feature vector characterizing image quality defects within the test image for the ROI type and on which basis whether print quality of the printing device has degraded below a specified acceptable print quality level is assessable.

15. A method comprising:
comparing, by a processor, regions of interest (ROIs) within a reference image to corresponding ROIs within a test image corresponding to the reference image and printed by a printing device, for each of a plurality of ROI types; and
generating, by the processor, a feature vector characterizing image quality defects within the test image, based on results of the comparing, for each ROI type,
wherein whether print quality of the printing device has degraded below a specified acceptable print quality level is assessable based on the feature vectors.
